(19) United States
(12) Patent Application Publication
(10) Pub. No.: US 2022/0367959 A1
(43) Pub. Date: Nov. 17, 2022

(54) BATTERY SPACER FOR A BATTERY POWERED HAND TOOL

(71) Applicant: Derek Ford, Lethbridge (CA)

(72) Inventor: Derek Ford, Lethbridge (CA)

(21) Appl. No.: 17/317,733

(22) Filed: May 11, 2021

(51) Int. Cl. H01M 50/289; H02J 7/00; H01M 50/247

(52) U.S. Cl. CPC H01M 50/289; H02J 7/0045; H01M 50/247; H01M 2220/30

(57) ABSTRACT

Disclosed is a spacer that is located between a rechargeable battery pack and an electrical receptacle of a battery powered hand tool (e.g., a cordless electric drill) within which the battery pack is removably received to be detachably connected to electrical contacts so that battery power is supplied to operate the tool. The spacer has a U-shape with a pair of flat sides and wings that run along the sides and bend upwardly therefrom. The spacer slides into the electrical receptacle of the hand tool such that the upturned wings that run along the sides of the spacer slide over and against respective sidewalls that enclose the receptacle so as to hold the spacer in place. The spacer prevents the battery pack from shifting relative to the receptacle and moving out of its connection to the electrical contacts of the receptacle.

### BACKGROUND OF THE INVENTION

### 1. Field of the Invention

This invention relates to a battery spacer to be located between an electrical receptacle of a conventional battery powered hand tool (e.g., a cordless electric drill) and a conventional battery pack that supplies power to the tool. The battery spacer prevents the battery pack from wobbling and the electrical contacts thereof from moving out of their intended electrical connection to electrical contacts located within the electrical receptacle at which the battery pack is connected to the tool. By virtue of the foregoing, the supply of battery power provided by the battery pack to the hand tool will not be interrupted if the tool is shaken or vibrated during use.

### 2. Background Art

Battery powered hand tools have long been used at locations that are remote from an available source of AC power to which an electrical power cord is otherwise connected at an electrical wall receptacle. Such battery powered hand tools are typically powered by a detachable battery pack. The conventional rechargeable battery pack that is carried by the hand tool is known to be heavy and bulky. As consequence of its size and weight and the wear that is caused by the battery pack being repeatedly attached to and removed from the tool, the battery pack will sometimes wobble and shift its position relative to an electrical receptacle at which the battery pack is attached to the tool. In this case, the electrical contacts of the battery pack will move out of their electrical connection to the electrical contacts at the electrical receptacle of the tool which may result in an undesirable interruption of the battery power required to operate the tool.

Accordingly, what would be useful is the availability of a low cost, easy-to-use battery spacer to be inserted between the battery pack and the electrical receptacle of the battery powered hand tool to hold the battery pack in place and prevent its wobbling and moving out of its intended electrical connection to the electrical contacts of the hand tool should the hand tool be shaken or subjected to vibrations during use.

### SUMMARY OF THE INVENTION

In general terms, disclosed herein is a low cost, easy to insert battery spacer to be removably received within an electrical receptacle of a terminal housing of a conventional battery powered hand tool (e.g., a cordless electric drill) so as to lie between the electrical receptacle and a conventional battery pack that is removably attached to the hand tool to provide battery power thereto. The battery spacer has a U-shaped configuration with a horizontal base extending between a pair of flat vertical sides. A fold or score line is formed along each of the flat sides of the battery spacer at which the sides are bent to create upturned wings. An adhesive patch is located underneath the horizontal base of the spacer to hold the spacer in place when it is located within the electrical receptacle of the terminal housing of the tool.

The battery spacer is pushed inwardly of the terminal housing so as to slide through the electrical receptacle and into engagement with a terminal block that is located within the electrical receptacle at which a set of upstanding electrical contacts provide battery power to the hand tool. At the same time, the upturned wings of the battery spacer slide along and against respective sidewalls of the terminal housing to hold the spacer in place within the electrical receptacle of the hand tool. The battery pack is received by the electrical receptacle, whereby electrical contacts of the battery pack are electrically connected to the set of upstanding electrical contacts within the electrical receptacle, and the battery spacer is located between battery pack and the electrical receptacle. The battery spacer takes up any space between the battery pack and the electrical receptacle to prevent the battery pack from wobbling and shifting its position relative to the electrical receptacle. By virtue of the foregoing, the electrical contacts of the battery pack are unlikely to move out of their intended electrical connection to the electrical contacts of the hand tool so as to avoid an interruption of battery power being supplied to the hand tool should it be shaken or vibrated during use.

### BRIEF DESCRIPTION OF THE DRAWINGS

FIG. 1 is an exploded view to illustrate the removable attachment of a battery pack to a battery powered hand tool with a battery spacer which forms the present invention to be located therebetween;

FIG. 2 shows the battery spacer of FIG. 1 lying flat prior to it being located between the battery pack and the hand tool;

FIG. 3 shows the battery spacer of FIG. 2 with sides of the spacer folded to establish upturned wings;

FIG. 4 shows a terminal housing of the battery powered hand tool of FIG. 1 having an electrical receptacle recessed therein at which electrical contacts are located to be electrically connected to electrical contacts of the battery pack when the battery pack is attached to the hand tool; and

FIG. 5 is a cross section showing the battery pack electrically connected to the battery powered hand tool to provide power thereto with the battery spacer located between the battery pack and the electrical receptacle of the terminal housing of the hand tool.

### DESCRIPTION OF THE PREFERRED EMBODIMENT

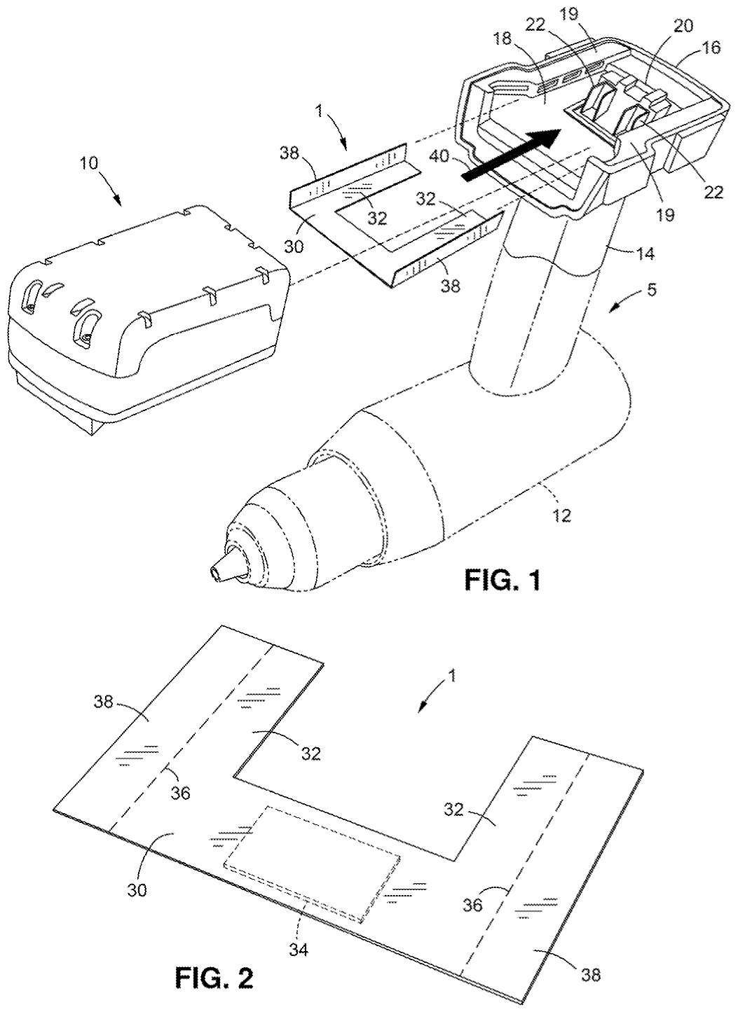

Referring concurrently to FIGS. 1-5 of the drawings, there is shown a low cost battery spacer (i.e., a shim) 1 that is easily and conveniently inserted between a conventional battery powered hand tool 5 and a rechargeable battery pack 10 that is removably attached to the hand tool to provide battery power needed to operate the tool. As will be explained in greater detail hereinafter, by inserting the spacer 1 between the battery powered hand tool 1 and its battery pack 10, the electrical connection between the tool and the battery pack will be advantageously maintained over time so that the tool will not experience a loss of battery power as a consequence of the battery pack 10 wobbling or being shaken during use and thereby experiencing a break in its electrical connection to the tool.

By way of example only, the battery powered hand tool 5 shown in FIG. 1 for which the battery spacer 1 of this invention has particular application is a Milwaukee 18 volt cordless electric drill. However, it is to be understood that the advantage provided by the battery spacer 1 herein disclosed is not limited to the aforementioned hand tool. That is, by changing its dimensions, the battery spacer 1 can be used with other battery powered hand tools having complementary battery packs to be connected thereto. Therefore, the particular hand tool 5 with which the battery spacer 1 is associated should not be considered as a limitation of this invention.

In the example shown in FIG. 1, the hand tool 5 includes a drill body 12 to which a drill bit (not shown) is removably attached and rotated for making a hole. A handle 14 of the tool 5 is connected at one end thereof to the drill body 12 and at the opposite end to a terminal housing 16. A trigger (also not shown) that is depressed to power the tool and rotate the drill bit is accessible to a user at the handle 14.

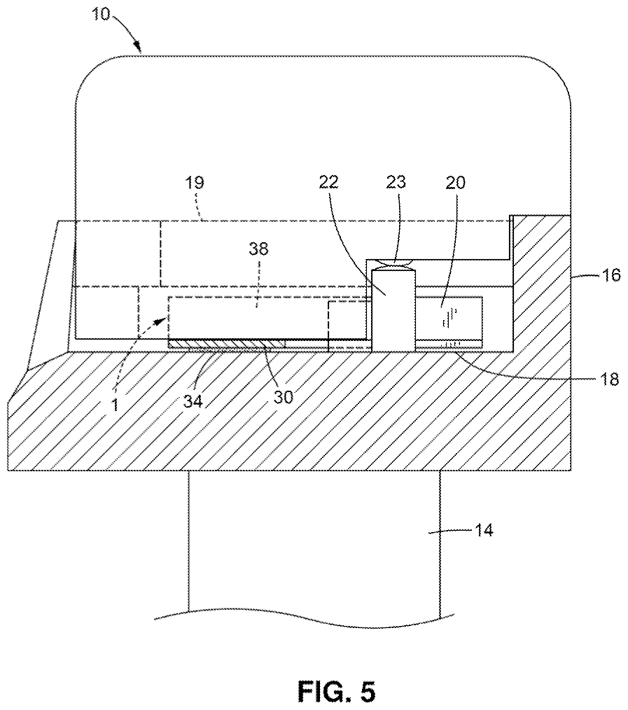

As is best shown in FIGS. 1 and 4, the terminal housing 16 at the opposite end of the handle 14 of the battery powered hand tool 5 has an electrical receptacle or socket 18 recessed therein that is enclosed by sidewalls 19 of the terminal housing 16. The electrical receptacle 18 of the terminal housing 16 is sized and shaped to slidably receive and accommodate the battery pack 10 (of FIG. 1) therewithin when the battery pack is removably attached to hand tool 5. By way of additional example, the battery pack 10 is a Milwaukee M18 lithium battery. Located within the electrical receptacle 18 of the terminal housing 16 is a terminal block 20. Mounted on the terminal block 20 and standing upwardly from the electrical receptacle 18 are a pair of electrical (e.g., female) contacts 22. The number and shape of the electrical contacts 22 of the terminal block 20 at the electrical receptacle 18 correspond to the number and shape of the (e.g., male) electrical contacts (designated 23 in FIG. 5) of the battery pack 10 that will be electrically connected to contacts 22 when the battery pack is attached to the hand tool 5. In this regard, the battery pack 10 that is slidably and removably attached to the terminal housing 16 of the hand tool 5 to enable power to be provided to the tool is also conventional and dependent upon the particular hand tool to be powered.

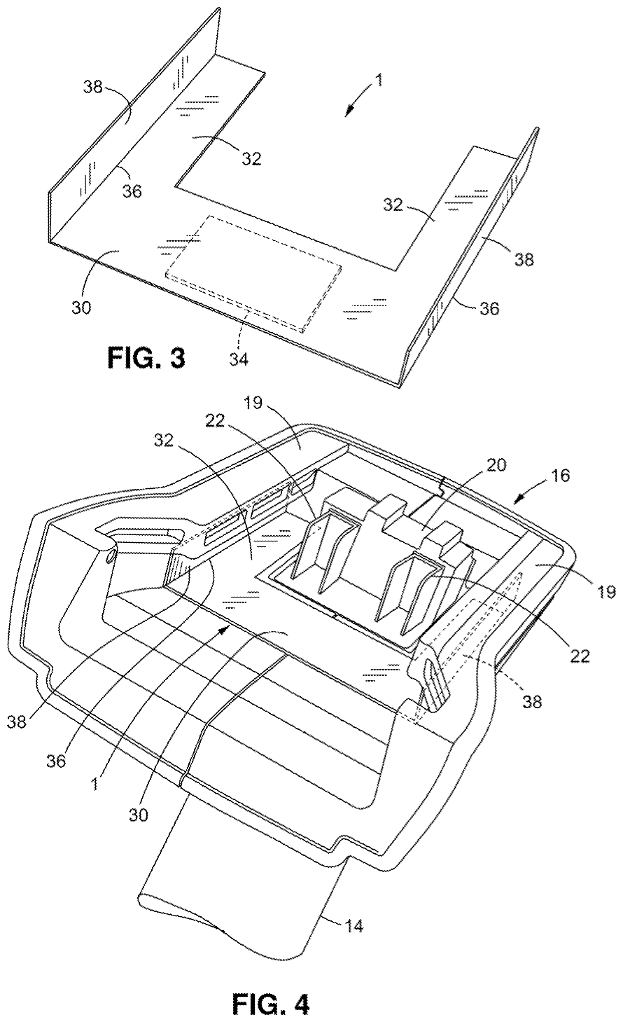

In accordance with the present invention and referring specifically to FIGS. 2 and 3 of the drawings, details are now provided of the battery spacer 1 and the method for inserting the battery spacer between the electrical hand tool 1 (within the electrical receptacle 18 of the terminal housing 16) and the battery pack 10. The battery spacer 1 is preferably manufactured from a flexible plastic material such as that having a petg filament composition. However, other suitable materials including, but not limited to, those having fiberglass and carbon fiber compositions can also be used during manufacture to change the stiffness and rate of wear of the spacer 1. It is contemplated that the battery spacer 1 will be manufactured by a conventional 3D printing process. However, other spacer manufacturing techniques (e.g., stamping) may also be employed.

The battery spacer 1 has a generally U-shaped configuration that is initially laid flat (best shown in FIG. 2) to facilitate the packaging and transport of a plurality of spacers stacked one above the other. The battery spacer 1 includes a horizontal base 30 and a pair of flat vertical sides 32 that are coextensively connected to and extend upwardly from the horizontal base. An adhesive patch 34 over which a removable cover is attached is bonded underneath the base 30 of spacer 1.

Each flat vertical side 32 of the battery spacer 1 has a longitudinal score or fold line 36 formed therein. The outside edge of each side 32 of the spacer 1 is folded upwardly along fold line 36 to establish an upturned wing 38 (best shown in FIG. 3). The upturned wings 38 of the battery spacer 1 make an angle of about 90° with respective ones of the flat sides 32. The upturned wings 38 located at opposite sides of the battery spacer 1 are separated from one another by a distance that is sufficient to enable the battery pack 10 to be received therebetween such that the battery pack will be seated on the flat sides 32 of spacer 1.

FIG. 1 shows the battery powered hand tool 5 prior to the attachment of the battery spacer 1 and the battery pack 10. The battery pack 10 is removably attached to the terminal housing 16 of the hand tool 5 by first peeling the cover off the adhesive patch 34 that is located underneath the horizontal base 30 of the folded battery spacer 1 shown in FIG. 3. The battery spacer 1 is then pushed inwardly through the electrical receptacle 18 of the terminal housing 16 in the direction of the reference arrow 40 shown in FIG. 1.

The U-shaped battery spacer 1 continues to slide through the electrical receptacle 18 of the terminal housing 16 until the terminal block 20 within receptacle 18 is received between the flat vertical sides 32 of the spacer 1 and against the horizontal base 30 that extends between the vertical sides 32 (best shown in FIG. 4). At the same time, the upturned wings 38 of the battery spacer 1 slide along and against the sidewalls 19 of the terminal housing 16 that encloses the recessed electrical receptacle 18 to generate a pressure to hold the spacer in place within the electrical receptacle (also best shown in FIG. 4). A downward pressure is then applied to the horizontal base 30 of the U-shaped battery spacer 1 to cause the adhesive patch 34 underneath the base 30 to adhere to the receptacle 18 below the spacer. The adhesive patch 34 prevents a relocation and inadvertent removal of the spacer 1 from the terminal housing 16 in a direction opposite to that represented by the reference arrow 40.

The battery pack 10 is pushed towards and into the electrical receptacle 18 of the terminal housing 16 of the hand tool 5 until the electrical contacts (designated 23 in FIG. 5) of battery pack 10 are electrically connected to respective ones of the upstanding electrical contacts 22 of the terminal block 20 that is surrounded by the battery spacer 1. FIG. 5 of the drawings shows the battery pack 10 removably attached to the battery powered hand tool 5 with the battery spacer 1 attached to the electrical receptacle 18 of the terminal housing 16 and the battery pack seated on the spacer so that battery power can be provided to the hand tool by way of electrical contacts 22 and 23.

By locating the battery spacer 1 of this invention between the battery pack 10 and the electrical receptacle 18 that is recessed within the terminal housing 16, the relatively heavy and bulky battery pack 10 will be unlikely to wobble or shift its position relative to receptacle 18 when the hand tool shakes or vibrates while in use or after the battery pack has been subjected to wear resulting from its being repeatedly attached to and removed from the hand tool. By virtue of the foregoing, a disconnection of the electrical contacts 23 of the battery pack 10 from the electrical contacts 22 of the hand tool 5 and an undesirable interruption of power being supplied to the hand tool can be avoided. That is, the battery spacer 1 functions as a buffer to fill the space and take up any slack between the battery pack 10 and the electrical receptacle 18 of the terminal housing 16 of the hand tool 5 to hold the battery pack 10 in its electrical connection to the hand tool 5. When the battery pack 10 is pulled outwardly from the electrical receptacle 18 and separated from the hand tool 5 to be recharged, the battery spacer 1 can be pulled off the hand tool and replaced with a new spacer or simply left in place to be reused in the manner described above.

1. A combination comprising:
a battery powered hand tool having a receptacle within which a set of electrical contacts are located;
a battery pack removably received by the receptacle of said battery powered hand tool and electrically connected to the set of electrical contacts located within said receptacle by which battery power is supplied by way of the set electrical contacts from said battery pack to said battery powered hand tool to operate said hand tool; and
a spacer located between the receptacle of said battery powered hand tool and said battery pack to prevent said battery pack from shifting relative to said receptacle and moving out of the electrical connection thereof to said set of electrical contacts.

2. The combination recited in claim 1, wherein said spacer lays on the receptacle of said battery powered hand tool to lie between said receptacle and said battery pack.

3. The combination recited in claim 1, further comprising an adhesive patch located on said spacer by which said spacer is adhesively attached to the receptacle of said battery powered hand tool to lie between said receptacle and said battery pack.

4. The combination recited in claim 1, wherein said spacer has a U-shape with a pair of sides that are spaced from one another, the set of electrical contacts located within the receptacle of said battery powered hand tool being received between the pair of sides of said spacer when said battery pack is removably received by said receptacle.

5. The combination recited in claim 4, wherein said U-shaped spacer also has a base extending between said pair of sides, said base lying against the set of electrical contacts within the receptacle of said battery powered hand tool when said battery pack is removably received by said receptacle.

6. The combination recited in claim 4, wherein said U-shaped spacer is slidable into and out of receipt by the receptacle of said battery powered hand tool.

7. The combination recited in claim 6, wherein there are a pair of sidewalls located at opposite sides of the receptacle of said battery powered hand tool between which said battery pack is located when said battery pack is removably received by said receptacle, and wherein each of the sides of said U-shaped spacer has a wing turning upwardly therefrom and lying against respective ones of the pair of sidewalls of said receptacle.

8. The combination recited in claim 7, wherein there is a fold line running between each side of said U-shaped spacer and the upwardly turned wing thereof, said upwardly turned wing bending at said fold line and turning upwardly from said side so as to lie against a respective one of the pair of sidewalls of said receptacle.

9. A method for attaching a battery pack to a battery powered hand tool within a receptacle of said hand tool so that said battery pack is electrically connected to a set of electrical contacts that are located within said receptacle and battery power is supplied by way of said set of electrical contacts from said battery pack to said battery powered hand tool to operate said hand tool, said method comprising the step of positioning a spacer within the receptacle of said battery powered hand tool such that said spacer lies between said receptacle and said battery pack to prevent said battery pack from shifting relative to said receptacle and moving out of the electrical connection of said battery pack to said set of electrical contacts.
